(19) United States
(12) Patent Application Publication
(10) Pub. No.: US 2018/0119872 A1
(43) Pub. Date: May 3, 2018

(54) FLEXIBLE CRYOGENIC HOSE FOR LIQUEFIED NATURAL GAS (LNG) TRANSFERS

(71) Applicant: Excelerate Energy Limited Partnership, The Woodlands, TX (US)

(72) Inventor: Mark K. LANE, Key Largo, FL (US)

(21) Appl. No.: 15/524,195

(22) PCT Filed: Nov. 3, 2015
(86) PCT No.: PCT/US2015/058800

§ 371 Date: May 3, 2017

Related U.S. Application Data
(60) Provisional application No. 62/075,747, filed on Nov. 5, 2014.

(51) Int. Cl. F16L 59/14; F16L 11/11

(52) U.S. Cl. CPC F16L 59/141; F16L 11/11

(57) ABSTRACT

A flexible cryogenic hose for liquefied natural gas (LNG) transfers is described. A cryogenic LNG transfer hose includes an LNG transfer hose carcass including an inner coil forming an inner diameter of the LNG transfer hose carcass, at least one elongate sheath form-fitted about an outer surface of the inner coil, wherein the at least one elongate sheath is impermeable to natural gas, and an outer coil forming an outer diameter of the LNG transfer hose carcass. A marine LNG transfer system includes a cryogenic flexible hose fluidly coupling a transferring LNG carrier located offshore and an LNG receiving vessel, the cryogenic flexible hose comprising a coil, at least one natural gas impermeable elongate sheath form-fit about an outer surface of the coil, and wherein LNG flows through the cryogenic flexible hose during transfer of LNG between the transferring LNG carrier and the LNG receiving vessel.

### BACKGROUND

### 1. Field of the Invention

Embodiments of the invention described herein pertain to the field of marine cryogenic transfer equipment. More particularly, but not by way of limitation, one or more embodiments of the invention enable a flexible cryogenic hose for liquefied natural gas (LNG) transfers.

### 2. Description of the Related Art

It is often advantageous to transport natural gas, which is normally in gaseous form at ambient conditions, as a sub-cooled liquid referred to as liquefied natural gas (LNG). For example, although natural gas is typically transported from the location produced to the location consumed as a gas by pipeline, there are circumstances where doing so may not be feasible. For example, the location of production and the location of demand may be separated in such a manner that ocean transport aboard a vessel over much of the distance to market is more economically feasible than transport via pipeline. Without an effective way to transport the gas to a location where there is a commercial demand, opportunities to monetize the gas may be lost. As such, natural gas is often transported across the ocean in a liquefied state by vessel.

Liquefaction of natural gas facilitates storage and transportation of the gas. LNG, largely consisting of methane mixed with other hydrocarbon components, takes up only about 1/600 of the volume that the same amount of natural gas does in its gaseous state. LNG is produced by cooling the natural gas below its boiling point (about −160° C. at atmospheric pressure, depending on cargo grade). The LNG may be transported and stored in cryogenic containers slightly above atmospheric pressure. Upon reaching the location of intended use, the LNG may be converted back to its gaseous form by adding heat and thereby raising the temperature above its boiling point.

LNG is typically stored and transported onboard cryogenic storage vessels called LNG carriers or LNG tankers, which are designed to carry LNG (mostly methane), or is sometimes stored on ethane carriers, which may also carry LNG. In each case, the natural gas is stored onboard a vessel in insulated storage tanks.

It is often desirable to transfer the LNG from one vessel to another vessel, a process termed “ship to ship transfer” (STS transfer). For example, it may be desirable to transfer LNG from a large LNG tanker to a smaller shuttle vessel in order to gain access to inland water locations. In another example, it may be desirable to transfer LNG from an LNG carrier used for long haul transportation to a regasification vessel moored at, or located nearby, a delivery location such as a power plant. In addition, STS transfers may become necessary if an LNG carrier transporting LNG is damaged in a collision mid-route, or otherwise becomes inoperable during a voyage. In such an instance, it may become necessary to transfer LNG cargo to a replacement vessel so that the replacement vessel may deliver the cargo.

In order to conduct STS transfer operations, a flexible, composite cryogenic hose is typically employed to convey the LNG from the cargo tanks of one vessel into the cargo tanks of a second vessel. In the case of emergency transfers, conventionally, a set of three or four meter-long hoses may be stored onboard a carrier vessel, which hoses may be flanged together to make a jumper hose for unplanned events where a temporary piping arrangement may be needed. For planned transfers, a set of hoses about ten meters to twenty-five meters in length is typically employed. FIG. 1 illustrates a marine side-by-side STS transfer operation employing flexible hoses of the prior art. As shown in FIG. 1, supply vessel 100 is transferring cryogenic liquid through conventional hoses 110 to receiving vessel 105.

STS transfer hoses are conventionally constructed using an inner wire that is coiled around a mandrel. Over the wire are sheets of lining, typically polyester fabric lining for LNG hoses. The fabric is a cloth about eighteen inches wide that is wrapped onto the stainless steel coil like wrapping paper. Around the fabric layers is a final outer stainless steel wire. Stainless steel end flanges are screwed on and swaged in place to complete the hose.

A difficulty unique to STS transfers of LNG (as opposed to the transfer of other types of hydrocarbons), is the need to purge the hoses of remaining vapors at the completion of transfer operations, since the handling of a gassy hose containing natural gas does not meet certain risk protocols. Once the transfer of LNG has been completed, some natural gas remains inside the hoses. If the hoses are disconnected while still containing natural gas, vapors may be released into the atmosphere, which is undesirable due to safety concerns such as fire risk. As a result, LNG hoses are typically drained and purged once a transfer has been accomplished. Draining involves a water spray process that causes the LNG to evaporate back into the cargo system. Purging is a conventional practice that involves introducing ultra-dry nitrogen gas into the hose under pressure to remove by flushing or displacement the remaining methane and other natural gas vapors. Ideally, once a hose has been drained and purged, it may be disconnected. Conventionally, an acceptable level of methane remaining in the hose is less than 2% by volume. At this acceptable level the hose may be disconnected.

One problem that arises in STS transfer operations is that the inner layers of polyester fabric in the hoses trap natural gas. The trapped gas makes it difficult to purge the methane out of the hose carcass. Once the gas has been initially purged to an acceptable level, the carcass may then “bleed-off” methane, causing methane from the carcass to refill the hose. The bleed-off causes a cyclic draining, purging and waiting process that is time consuming, and neither the transferring nor receiving vessel can leave the transfer site until the hoses are disconnected. Delays caused by the repeated draining and purging of hoses may cause the delivery vessel to be late to depart the port or transfer location by as much as six to seven hours, resulting in demurrage. These delays may also cause additional safety concerns if advancing weather systems may adversely affect the safety of the vessels involved in the STS operation.

As is apparent from the above, current flexible STS hoses suffer from bleed-off and may cause delivery vessel delays. Therefore, there is a need for an improved flexible cryogenic hose for LNG transfers.

### SUMMARY

Embodiments described herein generally relate to a flexible cryogenic hose for liquefied natural gas (LNG) transfers. A flexible cryogenic hose for LNG transfers is described.

An illustrative embodiment of a cryogenic liquefied natural gas (LNG) transfer hose includes an LNG transfer hose carcass including an inner coil forming an inner diameter of the LNG transfer hose carcass, at least one elongate sheath form-fitted about an outer surface of the inner coil, wherein the at least one elongate sheath is impermeable to natural gas, and an outer coil forming an outer diameter of the LNG transfer hose carcass. In some embodiments, the at least one elongate sheath is made of a perfluorinated compound. In certain embodiments, the at least one elongate sheath comprises polytetrafluoroethylene (PTFE). In some embodiments, the at least one elongate sheath is made of high-modulus polyethylene (HMPE). In some embodiments, the LNG transfer hose carcass includes a series of layers of polyester film and polyester fabric wrapped around the at least one elongate sheath and beneath the outer coil. In certain embodiments, the LNG transfer hose carcass includes a layer of polyamide film wrapped around the series of layers of polyester film and polyester fabric, and wherein the outer coil is wound around the layer of polyamide film. In some embodiments, the at least one elongate sheath is impermeable to LNG and gaseous natural gas. In certain embodiments, the at least one elongate sheath is heat-shrunk about an outer surface of the inner coil. In some embodiments, the at least one elongate sheath is stretchedly form-fitted about the outer surface of the inner coil.

An illustrative embodiment of a marine liquefied natural gas (LNG) transfer system includes a cryogenic flexible hose fluidly coupling a transferring LNG carrier located offshore and an LNG receiving vessel, the cryogenic flexible hose including a coil, at least one natural gas impermeable elongate sheath form-fit about an outer surface of the coil, and wherein LNG flows through the cryogenic flexible hose during transfer of the LNG between the transferring LNG carrier and the LNG receiving vessel. In some embodiments, there are two of the natural gas impermeable elongate sheaths form-fit about an outer surface of the coil, and wherein the two elongate sheaths are layered in series. In some embodiments, the cryogenic flexible hose further includes a second coil coupled around the at least one natural gas impermeable elongate sheath. In certain embodiments, the cryogenic flexible hose further includes a series of layers of polyester film and polyester fabric wrapped around the at least one elongate sheath beneath the second coil. In some embodiments, the at least one elongate sheath is made of polytetrafluoroethylene (PTFE). In certain embodiments, the at least one elongate sheath is one of heat-shrunk form-fit, stretchedly form-fit, or a combination thereof.

An illustrative embodiment of a method of constructing a flexible cryogenic hose for liquefied natural gas (LNG) transfer includes winding an inner stainless steel coil about a rotating mandrel to form a tubular skeleton, placing a polytetrafluoroethylene (PTFE) tubular sheath longitudinally around the inner stainless steel coil to form a natural gas barrier, wrapping a series of layers of polyester fabric and polyester film about the PTFE tubular sheath, enfolding a covering of polyamide film around the series of layers of polyester fabric and polyester film, winding an outer stainless steel coil about the covering polyamide film to form a tubular carcass, removing the tubular carcass from the mandrel, and applying a stainless steel fitting to each end of the carcass to form an LNG transfer hose.

An illustrative embodiment of a cryogenic liquefied natural gas (LNG) transfer system includes a plurality of polytetrafluoroethylene (PTFE) tubular sheaths forming an LNG transfer hose.

An illustrative embodiment of a flexible cryogenic conveyant transfer hose system includes a cryogenic conveyant having a transfer temperature of between −196° C. and −120° C., a flexible cryogenic conveyant transfer hose including at least one elongate sheath forming a barrier between an inner diameter of the flexible cryogenic conveyant transfer hose and carcass material outwards of the at least one elongate sheath, and wherein the at least one elongate sheath is impermeable to the cryogenic conveyant flowing through the inner diameter. In some embodiments, the cryogenic conveyant is liquefied natural gas (LNG) and the transfer temperature is between −125° C. and −160° C. In certain embodiments, the at least one elongate sheath comprises a perfluorinated polymer. In some embodiments, the at least one elongate sheath is made of polytetrafluoroethylene (PTFE). In certain embodiments, the at least one elongate sheath is made of high-modulus polyethylene (HMPE). In some embodiments, the at least one elongate sheath is one of shrink-fit, stretched, or a combination thereof around a coil of the flexible cryogenic conveyant transfer hose. In certain embodiments, the carcass material outwards of the at least one elongate sheath includes polyester fabric and polyester film.

In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings in which:

FIG. 1 is a perspective view of a side-by-side ship to ship transfer system of the prior art.

FIG. 2 is a partial perspective view of an illustrative embodiment of a flexible cryogenic hose.

FIG. 3 is a cross sectional view across line 3-3 of FIG. 2 of an illustrative embodiment of a carcass of an exemplary flexible cryogenic hose.

FIG. 4 is an enlarged view of FIG. 3 of layers of a carcass of an illustrative embodiment.

FIG. 5 is a schematic diagram of surrounding a coil with a sheath of an illustrative.

FIG. 6 is a schematic diagram of a sheath of an illustrative embodiment shrink-fit onto a coil.

FIG. 7 is a cross sectional view across line 7-7 of FIG. 2 of a flexible cryogenic hose of an illustrative embodiment having a cryogenic conveyant flowing through the exemplary hose.

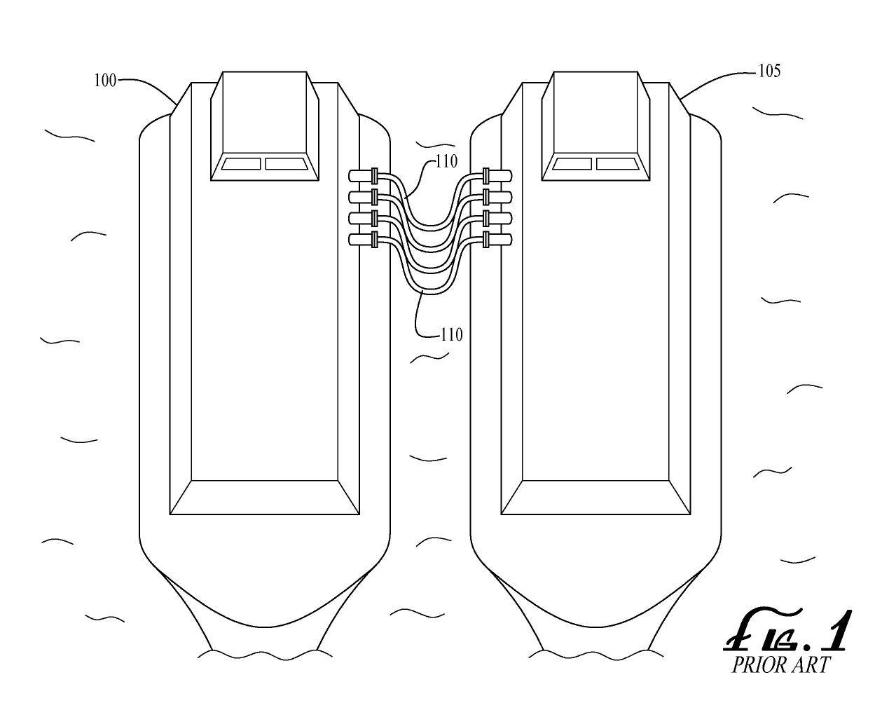

While the invention is susceptible to various modifications and alternative forms, specific embodiments thereof are shown by way of example in the drawings and may herein be described in detail. The drawings may not be to scale. It should be understood, however, that the embodiments described herein and shown in the drawings are not intended to limit the invention to the particular form disclosed, but on the contrary, the intention is to cover all modifications, equivalents and alternatives falling within the scope of the present invention as defined by the appended claims.

### DETAILED DESCRIPTION

A flexible cryogenic hose for liquefied natural gas (LNG) transfers will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

As used in this specification and the appended claims, the singular forms “a”, “an” and “the” include plural referents unless the context clearly dictates otherwise. Thus, for example, reference to a hose includes one or more hoses.

“Coupled” refers to either a direct connection or an indirect connection (e.g., at least one intervening connection) between one or more objects or components. The phrase “directly attached” means a direct connection between objects or components.

As used herein, the term “offshore,” with respect to a cryogenic conveyant transfer operation, means at least partially on a navigable body of water. Thus for example, an LNG transfer operation taking place in the open ocean, between two vessels moored at or near a dock, or between one vessel and a dock or the shore may be an offshore ship-to-ship (STS) transfer and/or offshore LNG transfer.

One or more embodiments provide a flexible cryogenic hose for LNG transfers. While so as not to obscure the invention, illustrative embodiments are described in terms of an LNG side-by-side STS transfer operation, nothing herein is intended to limit the invention to that embodiment. Illustrative embodiments may be equally applicable to tandem transfers, transfers of other cryogenic fluids that may absorb into hose carcasses and bleed-off such as nitrogen, hydrogen, oxygen, ethane, propane or butane, and/or onshore transfers.

Illustrative embodiments of a flexible cryogenic hose for LNG transfers are described. An illustrative embodiment of a flexible, cryogenic LNG transfer hose may include one or more natural gas impermeable sheaths, such as polytetrafluoroethylene (PTFE) sheaths. The sheaths may smoothly slide, shrink and/or stretch around the entire length of a stainless steel 316 coil and snugly fit about the coil. A series of polyester fabric and polyester film layers may be wrapped over the sheaths, followed by a polyamide outer cover that may serve as a logo sheet. A final outer stainless steel coil may complete the carcass construction. The one or more sheaths of illustrative embodiments may create a barrier inside the hose carcass that is impermeable to natural gas and/or LNG. The barrier may prevent absorption of natural gas into the hose carcass and reduce or eliminate bleed-off. Reducing or eliminating bleed-off may reduce the time necessary to drain and purge the hose at the completion of STS transfer operations, which may save demurrage and may alleviate safety concerns due to advancing weather systems.

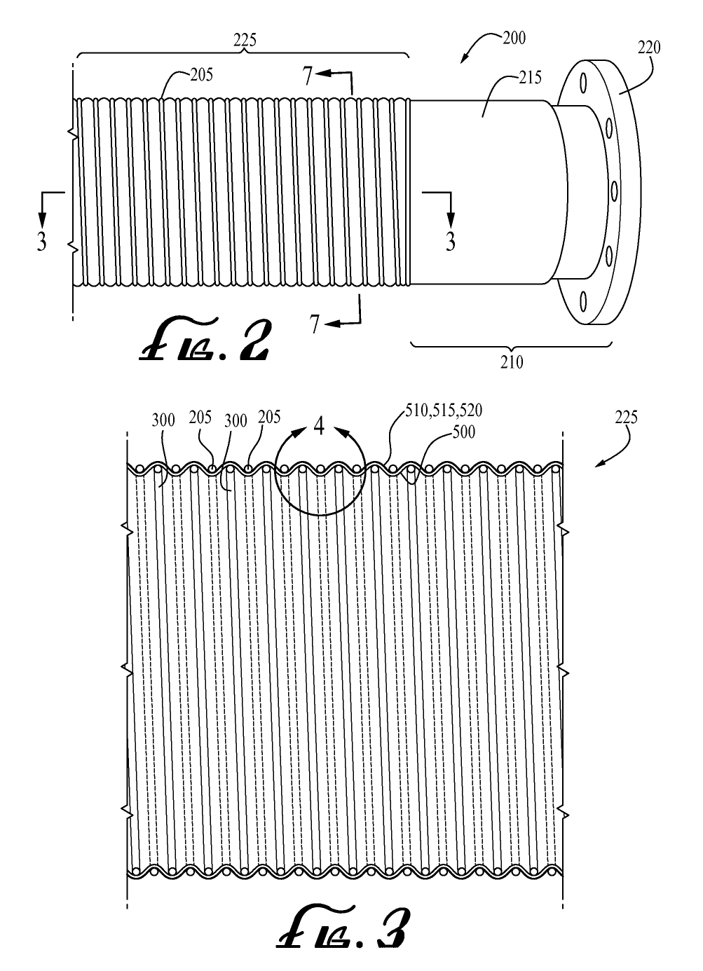

FIG. 2 illustrates an exemplary cryogenic hose of an illustrative embodiment. Hose 200 may be flexible, tubular and/or elongate in shape such that LNG, natural gas and/or another cryogenic liquid and/or its associated gas may flow through its inner diameter (the inside of hose 200). Hose 200 may be between one and sixteen inches in diameter, inclusive, and up to one-hundred feet long. In embodiments where hose 200 is a jumper hose, it may be shorter in length, for example between nine feet and fifteen feet in length. In an illustrative embodiment, hose 200 may have a maximum elongation of about 10% on proof pressure, an electrical resistance of less than 1.0 ohm/m for bore sizes of 2 inches and above, a maximum twist of about 10 degrees p/m, a maximum working pressure of about 150 psi (10.5 bar) and/or a temperature range from −196° C. up to +50° C.

As shown in FIG. 2 and FIG. 7, cryogenic hose 200 includes a stainless steel outer coil 205 spring-wound and/or wrapped about the outer surface of carcass 225 of cryogenic hose 200. Fitting 210 may be stainless steel and secured to one or both ends of carcass 225 to form a spout, which fitting may include collar 215 and flange 220. Fitting 210 should be applied tensely so as to be gas tight. Collar 215 may be squeezed and/or slid into place. The end of carcass 225 where collar 215 may be applied may be taped, for example using duct tape, prior to application of collar 215 in order to hold the layers of carcass 225 in place during application. Flange 220 may be screwed and/or secured onto collar 215.

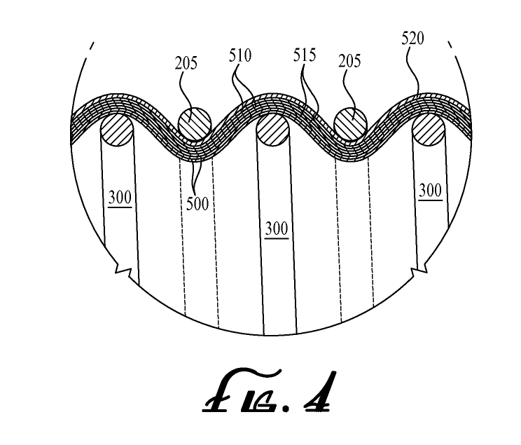

FIG. 3 illustrates an exemplary hose carcass 225. Carcass 225 may be constructed on a rotatable mandrel such that layers of carcass 225 may be easily wrapped about one another. As shown in FIG. 3 and in FIG. 7, carcass 225 may include both an outer coil 205 and an inner coil 300. Inner coil 300 may define inner diameter 605 of hose 200 and/or carcass 225, and outer coil 205 may define outer diameter 600 of hose 200 and/or carcass 225. Depending upon the spacing between windings of inner coil 300 and outer coil 205, sheath 500 and cover layer 520 may also contribute to defining inner diameter 605 and outer diameter 600, respectively. Both inner coil 300 and outer coil 205 may be 316 stainless steel, galvanized steel or another material with similar properties. As shown in FIG. 3, outer coil 205 and inner coil 300 may be offset from one another or biased such that the two layers interlock. For example outer coil 205 may fit within the gaps in the inner coil 300. Inner carcass 225 lining may be sandwiched in between inner coil 300 and outer coil 205.

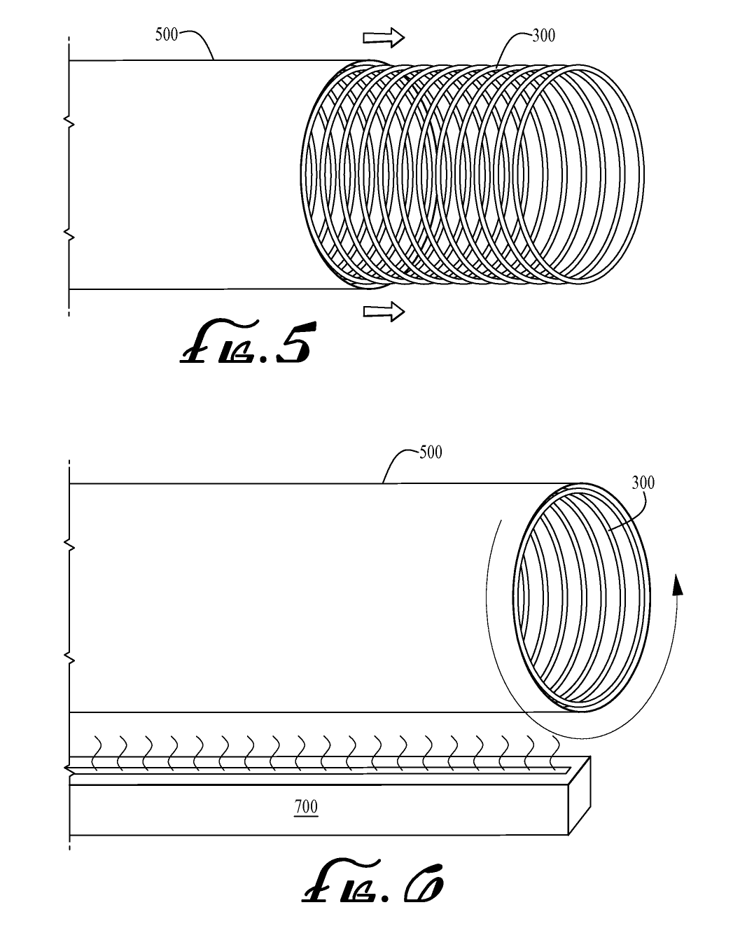

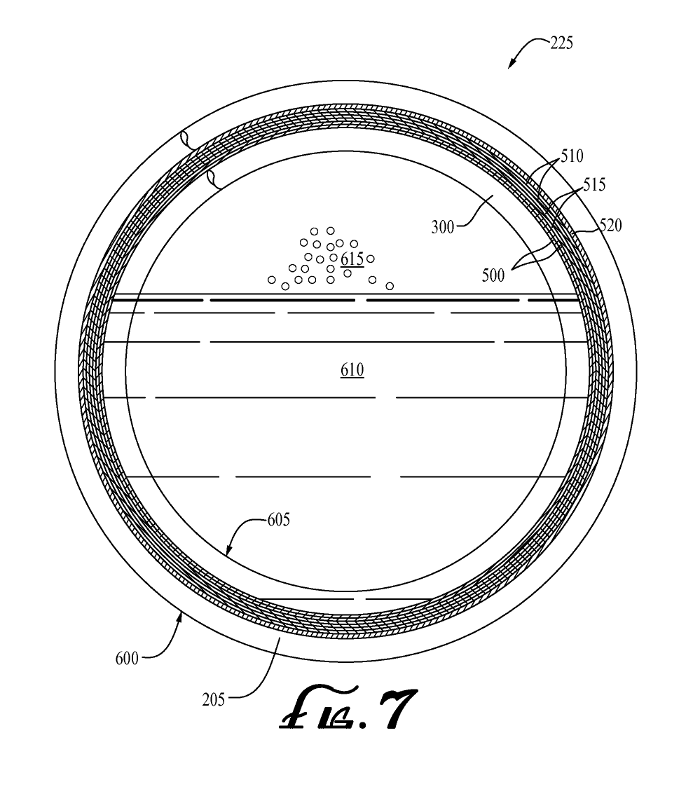

FIG. 4 illustrates the layers of inner carcass 225 materials and/or lining of hose 200 of illustrative embodiments. As shown in FIG. 4 and FIG. 7, one or more sheaths 500 may extend over inner coil 300, and underneath film layers 510, fabric layers 515, cover layer 520 and/or other lining materials making up carcass 225. As shown in FIG. 5 and FIG. 6, sheath 500 may slide, stretch and/or be snug-fit entirely around the outer longitudinal surface of inner coil 300. Sheath 500 may be elongate and/or tubular in shape and may slide, form-fittingly over, and/or stretch about the entire length of inner coil 300 in a fashion similar to footless pantyhose. In some embodiments, sheath 500 may be initially larger than inner coil 300 and may be heat sensitive and/or shrink-form about inner coil 300 such that inner coil 300 and sheath 500 fit tightly together. In heat shrinking embodiments, sheath 500 may be warmed with heater 700 in order to shrink-fit sheath 500 about inner coil 300, for example as illustrated in FIG. 6. As shown in FIG. 6, a mandrel (not shown) supporting sheath 550 and inner coil 300 may be rotated circumferentially to form-fit sheath 500 to inner coil 300 around the circumference of coil 300. The time to heat-shrink and the amount of heat (Btus) may vary with the material of sheath 500 and/or the thickness of sheath 500.

One or more conveyant-impermeable sheaths 500 may overlay the entire outer longitudinal surface of inner coil 300 to form a barrier to conveyants flowing through inner diameter 605 of carcass 225 of hose 200. As shown in FIG. 7, when liquid conveyant 610 and/or gas conveyant 615 flows through inner diameter 605 of carcass 225, such fluid may contact inner coil 300 and/or the inside of sheath 500, but not fabric layers 515 or film layers 510. Gas conveyant 615 may be boil-off from cryogenic liquid conveyant 610. For example where liquid conveyant 610 is LNG, gas conveyant 615 may be natural gas that may otherwise be absorbed by fabric layers 515 and/or film layers 510 without the benefit of illustrative embodiments.

Sheath 500 may be made of a stretchable, shrinkable and/or form-fitting material and may be impermeable to natural gas, LNG and/or another cryogenic conveyant and its associated boil-off transferred through hose 200. Sheath 500 may remain substantially flexible, not crack and/or not harden at cryogenic temperatures of about −160° C. or above, or about −196° C. or above. For example a synthetic flouroplastic such as polytetrafluoroethylene (PTFE), more commonly known as Hostaflon or Teflon® (a registered trademark of E. I. Du Pont De Nemours and Company) may be employed as sheath 500. Other similar perfluorinated compounds and/or perflourinated polymers may be employed as sheath 500. Thermoplastic polyethylene such as high-modulus polyethylene (HMPE), polyvinylchloride and/or materials falling within the class of polypropylenes, polyethylenes and/or polyolefins having characteristics that meet the requirements described herein may also be employed for sheath 500.

Sheath 500 may be smooth without any gaps, holes, ridges and/or imperfections and may be slideable, stretchable over, and/or tightly fit about inner coil 300 with minimal friction. One, two or three or more sheaths 500 may be layered over inner coil 300 to create a natural gas and/or LNG impermeable layer, which may reduce or eliminate seepage of gas through sheath 500 and into the lining of carcass 225 outwards of sheath 500, for example film layers 510 or fabric layers 515. In embodiments where two or more sheaths 500 are employed, sheaths 500 may be layered on top of one another in series and/or sheaths 500 may be next to one another with edges of sheaths 500 overlapping to avoid any breaks in the natural gas impermeable barrier provided by sheath 500. The ends of sheath 500 may be tucked and swaged into end fittings 210 along with the other film layers 510, fabric layers 515 and coils 300, 205 of hose carcass 225. Sheath 500 may be about 300-600 gauge in thickness (3-6 mil in an inch bases system of units), depending upon the material selected for sheath 500.

Returning to FIG. 4, a series of fabric layers 515 and film layers 510 may be included in the lining of carcass 225 of hose 200 and be wrapped around sheath 500 between inner coil 300 and outer coil 205. Fabric layers 515 may, for example, be polyester fabric such as polyethylene terephthalate (PET). Fabric layers 515 may be applied over sheath 500 by wrapping fabric layers 515 in a fashion similar to wrapping paper. Film layers 510 may be polyester film about 0.2 mm thick and about eighteen inches wide, and may be wrapped over fabric layers 515 in a similar fashion to the wrapping of fabric layers 515. Melinex® (a registered trademark of Imperial Chemical Industries PLC) and Mylar® (registered trademark of Dupont Teijin Films US Limited Partnership) are exemplary suitable polyester films. The edges of the film layers 510 and/or fabric layers 515 may overlap such that the underlying sheath 500 is completely covered. In some embodiments, the layering of fabric layers 515 and film layers 510 may be reversed such that film layers 510 wrap about sheath 500 and fabric layers 515 wrap around film layers 510. Lining outer covering 520 may be polyamide film, and may be placed around the last fabric layer 515, and/or film layer 510. Ultramid® (a registered trademark of BASF Aktiengesellschaft) is an exemplary polyamide film that may be employed as lining outer covering 520. Lining outer covering 520 may be used as a logo sheet.

In an exemplary embodiment, hose carcass 225 may be layered as follows: (1) an inner stainless steel 316 coil 300, (2) one, two or more sheaths 500 tightly fit around inner coil 300, (3) two fabric layers 515, which may be polyester fabric, wrapped about sheath 500, (4) two film layers 510, which may be polyester film, wrapped about the two fabric layers 515 (5) four fabric layers 515, (6) two film layers 510, (7) four fabric layers 515, (8) a continued series of four fabric layers 515 followed by two film layers 510, (9) a lining outer covering 520 of polyamide film, and (10) outer stainless steel coil 205. In some embodiments there may be between forty and seventy layers of film layers 510 and fabric layers 515 in between sheath 500 and outer coil 205. Other lining layers may be employed depending upon the substance conveyed and the temperature of the conveyed substance. For example, Bi-Oriented Polypropylene (BOPP) film may be employed in carcass 225 lining where a conveyant is colder than −200° C.

Illustrative embodiments may impose a natural gas or other cryogenic conveyant impermeable layer inside a cryogenic hose carcass, inwards of hose fabric and/or film lining. Sheath 500 barrier may prevent absorption of natural gas (or other conveyant gasses) into carcass 225, for example preventing and/or reducing natural gas seepage into fabric layers 515, film layers 510 and/or other hose lining. Illustrative embodiments may reduce bleed-off and/or the time required to drain and purge hoses used in LNG transfer operations, such as offshore and/or STS transfer operations. Reducing the time to drain and purge hoses may assist in preventing delays in cargo delivery and vessel schedules, reduce demurrage and may alleviate safety concerns from advancing weather systems.

A flexible cryogenic hose for liquefied natural gas (LNG) transfers has been described. Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the scope and range of equivalents as described in the following claims. In addition, it is to be understood that features described herein independently may, in certain embodiments, be combined.

1. A cryogenic liquefied natural gas (LNG) transfer hose comprising:
an LNG transfer hose carcass comprising:
an inner coil forming an inner diameter of the LNG transfer hose carcass;
at least one elongate sheath form-fitted about an outer surface of the inner coil, wherein the at least one elongate sheath is impermeable to natural gas; and
an outer coil forming an outer diameter of the LNG transfer hose carcass.

2. The cryogenic LNG transfer hose of claim 1, wherein the at least one elongate sheath is made of a perfluorinated compound.

3. The cryogenic LNG transfer hose of claim 2, wherein the perfluorinated compound is a perfluorinated polymer.

4. The cryogenic LNG transfer hose of claim 3, wherein the perfluorinated polymer is polytetrafluoroethylene (PTFE).

5. The cryogenic LNG transfer hose of claim 1, wherein the at least one elongate sheath comprises polytetrafluoroethylene (PTFE).

6. The cryogenic LNG transfer hose of claim 1, wherein the at least one elongate sheath is made of high-modulus polyethylene (HMPE).

7. The cryogenic LNG transfer hose of claim 1, wherein the LNG transfer hose carcass further comprises at least one layer of polyester fabric wrapped around the at least one elongate sheath and beneath the outer coil.

8. The cryogenic LNG transfer hose of claim 1, wherein the LNG transfer hose carcass further comprises a series of layers of polyester film and polyester fabric wrapped around the at least one elongate sheath and beneath the outer coil.

9. The cryogenic LNG transfer hose of claim 8, wherein there are at least fifty layers in the series of polyester fabric and polyester film layers.

10. The cryogenic LNG transfer hose of claim 8, wherein the LNG transfer hose carcass further comprises a layer of polyamide film wrapped around the series of layers of polyester film and polyester fabric, and wherein the outer coil is wound around the layer of polyamide film.

11. The cryogenic LNG transfer hose of claim 1, wherein the at least one elongate sheath is impermeable to LNG and gaseous natural gas.

12. The cryogenic LNG transfer hose of claim 1, wherein the at least one elongate sheath is heat-shrunk about an outer surface of the inner coil.

13. The cryogenic LNG transfer hose of claim 1, wherein the at least one elongate sheath is stretchedly form-fitted about the outer surface of the inner coil.

14. The cryogenic LNG transfer hose of claim 1, wherein there are two elongate sheaths layered in series.

15. A marine liquefied natural gas (LNG) transfer system comprising:
a cryogenic flexible hose fluidly coupling a transferring LNG carrier located offshore and an LNG receiving vessel, the cryogenic flexible hose comprising:
a coil;
at least one natural gas impermeable elongate sheath form-fit about an outer surface of the coil; and
wherein LNG flows through the cryogenic flexible hose during transfer of the LNG between the transferring LNG carrier and the LNG receiving vessel.

16. The marine LNG transfer system of claim 15, wherein there are two of the natural gas impermeable elongate sheaths form-fit about an outer surface of the coil, and wherein the two elongate sheaths are layered in series.

17. The marine LNG transfer system of claim 15, further comprising a second coil coupled around the at least one natural gas impermeable elongate sheath.

18. The marine LNG transfer system of claim 17, further comprising a series of layers of polyester film and polyester fabric wrapped around the at least one elongate sheath beneath the second coil.

19. The marine LNG transfer system of claim 15, wherein the coil is 316 stainless steel.

20. The marine LNG transfer system of claim 15, wherein the at least one elongate sheath is made of polytetrafluoroethylene (PTFE).

21. The marine LNG transfer system of claim 15, wherein the at least one elongate sheath comprises polytetrafluoroethylene (PTFE).

22. The marine LNG transfer system of claim 15, wherein the at least one elongate sheath comprises high-modulus polyethylene (HMPE).

23. The marine LNG transfer system of claim 15, wherein the at least one elongate sheath is one of heat-shrunk form-fit, stretchedly form-fit, or a combination thereof.

24. A method of constructing a flexible cryogenic hose for liquefied natural gas (LNG) transfer comprising:
winding an inner stainless steel coil about a rotating mandrel to form a tubular skeleton;
placing a polytetrafluoroethylene (PTFE) tubular sheath longitudinally around the inner stainless steel coil to form a natural gas barrier;
wrapping a series of layers of polyester fabric and polyester film about the PTFE tubular sheath;
enfolding a covering of polyamide film around the series of layers of polyester fabric and polyester film;
winding an outer stainless steel coil about the covering polyamide film to form a tubular carcass;
removing the tubular carcass from the mandrel; and
applying a stainless steel fitting to each end of the carcass to form an LNG transfer hose.

26. A flexible cryogenic conveyant transfer hose system comprising:
a cryogenic conveyant having a transfer temperature of between −196° C. and −120° C.;
a flexible cryogenic conveyant transfer hose comprising:
at least one elongate sheath forming a barrier between an inner diameter of the flexible cryogenic conveyant transfer hose and carcass material outwards of the at least one elongate sheath; and
wherein the at least one elongate sheath is impermeable to the cryogenic conveyant flowing through the inner diameter.

27. The flexible cryogenic conveyant transfer hose system of claim 26, wherein the cryogenic conveyant is liquefied natural gas (LNG) and the transfer temperature is between −125° C. and −160° C.

28. The flexible cryogenic conveying transfer hose system of claim 26, wherein the at least one elongate sheath comprises a perfluorinated polymer.

29. The flexible cryogenic conveying transfer hose system of claim 26, wherein the at least one elongate sheath is made of polytetrafluoroethylene (PTFE).

30. The flexible cryogenic conveying transfer hose system of claim 26, wherein the at least one elongate sheath is made of high-modulus polyethylene (HMPE).

31. The flexible cryogenic conveying transfer hose system of claim 26, wherein the at least one elongate sheath is one of shrink-fit, stretched, or a combination thereof around a coil of the flexible cryogenic conveyant transfer hose.

32. The flexible cryogenic conveying transfer hose system of claim 26, wherein the carcass material outwards of the at least one elongate sheath comprises polyester fabric and polyester film.

33. The flexible cryogenic conveying transfer hose system of claim 26, wherein the cryogenic conveyant is oxygen.
